(19) United States
(12) Patent Application Publication
(10) Pub. No.: US 2006/0149617 A1
(43) Pub. Date: Jul. 6, 2006

(54) Content information processing system and method

(75) Inventors: Noriko Yamashita, Tokyo (JP); Mao Sekiyama, Osaka (JP); Hikaru Deguchi, Tokyo (JP); Yasuo Yamada, Tokyo (JP); Tomiji Suzuki, Kanagawa (JP); Motoaki Shirai, Tokyo (JP); Takashi Munakata, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: WEB-I CO. LTD., Osaka-shi (JP); Mekiki Creates Co., Ltd., Tokyo (JP); Noriko Yamashita, Tokyo (JP)

(21) Appl. No.: 10/538,270

(22) PCT Filed: Dec. 25, 2003
(86) PCT No.: PCT/JP03/16727

§ 371 Date: Jun. 10, 2005

(30) Foreign Application Priority Data
Dec. 25, 2002 (JP) 2002-375647

(51) Int. Cl. G06Q 30/00

(52) U.S. Cl. 705/14

(57) ABSTRACT

A mechanism whereby a user can obtain a desired content via a communication network and a content distributor loses no profits. Identification information of each theater and each video content screened at the theater are registered. When a video content viewing request from a member is accepted, the theater which screens the content requested to be viewed is specified, the video content requested to be distributed is distributed to the member via a network, and an incentive for the video content distributed to the member is given to the theater which screens the video content requested to be viewed.

### TECHNICAL FIELD

The present invention relates to a technique of processing information related to a content distributed via a communication network such as a telephone network, the Internet, a LAN (Local Area Network), or a broadcasting network.

### BACKGROUND ART

Hitherto, systems and services for distributing contents such as movies via a network such as the Internet have been provided.

According to a method for distributing a content such as a movie, the digest of the content is distributed for propagation or video data with a lower quality than actual video images is distributed. Consequently, a movie to be actually screened at theaters is distinguished from a movie content distributed via the network, thus giving consideration so that the number of people who actually go to the movie is not reduced.

In order to prevent a reduction in the number of customers who actually go to a movie after the movie content is distributed over the Internet, the following systems (e.g., disclosed in Patent Document 1) are proposed: When the location of a theater which screens the movie coincides with the living place of a viewer who will receive the distribution of the movie content, the distribution of the movie content to the viewer is prevented.

Patent Document 1

Japanese Unexamined Patent Application Publication No. 2002-84515 (pp. 1-7, FIG. 1)

However, according to any of the above-mentioned approaches, a content supplier, who provides a content to each user as a physical material or at a real place without a communication network, has disadvantages in that after the content is distributed to the user via the communication network, the number of users (e.g., a viewer who watches a movie at a theater, a user who rents a videotape at a rental video shop, and the like) who receive content supply from the content supplier at real places.

Generally, content supply target users are customers living in an area where the shops and the theater for content supply are placed. If the content is distributed to a user who lives in the area or often visits the area, the benefit of the content supplier is disadvantageously reduced.

Further, when people living near the location of the theater are prevented from receiving the distribution of the movie as mentioned above, opportunities of the people, who live near the theater and will most probably be customers of the theater, to access the content are restricted. Contrarily, the people lose interest in the movie. Disadvantageously, it is not always useful for the theater and the viewers.

In addition, a movie viewer does not always go to a local theater. The viewer often goes to a faraway theater in consideration of the equipment or services of the theater. There is a disadvantage in that expectations do not always match actualities.

The above disadvantages are not limited to movies. Distributions of contents such as rental videos, digitized books and newspapers, music pieces, and maps have the similar disadvantages.

The present invention is made to overcome the above-mentioned disadvantages and an object of the present invention is to provide a mechanism whereby a user can receive the distribution of a desired movie content and a content supplier, who provides the content at real places, loses no profits.

### DISCLOSURE OF INVENTION

To overcome the above disadvantages, according to one aspect of the present invention, a content information processing apparatus is characterized by including: first storage means for storing information of each content to be provided to a user at a real place and information of each content supplier, who provides the content, such that the information is associated with the other information; viewing information processing means for specifying information of a content distributed to a terminal of the user via a network; viewing history storage means for storing viewing historical information including at least the specified information of the content distributed to the user; and incentive means for extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

Supplying a content to a user at a real place means that the content is provided without using a communication network such as the Internet. For example, a content such as a movie is screened at a theater, a content such as a video is sold or rented, or a content such as a book or a newspaper is sold, i.e., the content is physically supplied.

Information of a content supplier indicates information including identification information of the content supplier.

The apparatus may include distribution means for distributing a content to the terminal of each user.

Preferably, the apparatus is connectable via a communication network to a content distribution terminal for distributing a content to each user over a network, and the viewing information processing means obtains viewing historical information of a content distributed from the terminal of the content distributor to the user.

Preferably, the apparatus further includes second storage means for storing at least identification information of each user and assigned-area information indicating an area which the user belongs to. The first storage means further stores assigned-area information indicating an area which each content supplier belongs to, and the incentive means specifies area information of a user, to which the content is distributed, with reference to the second storage means, specifies the content supplier belonging to the specified area with reference to the first storage means, and gives an incentive to the specified content supplier for the content distributed to the user.

In this instance, area information indicates the address or living area of a content supplier or a user, or an area which the content supplier or the user determines as their area.

The apparatus may further include registration means for accepting registration of assigned-area information indicating an area, to which a viewer belongs, to store the information in the second storage means.

The viewing information processing means may provide viewing historical information to each content supplier.

Preferably, with reference to the first storage means, the viewing information processing means provides each user with the information pieces of the content suppliers registered in association with the content viewed by the user and accepts the information of a desired content supplier selected from among the content suppliers by the user, and the incentive means gives an incentive to the content supplier accepted from the user.

Preferably, the first storage means further stores advertising information of each content supplier. When providing each user with the information pieces of the content suppliers, the viewing information processing means provides the user with the advertising information pieces of the content suppliers stored in the first storage means.

The apparatus may further include user information storage means for relating each user to a content supplier to store the relationship therebetween. The incentive means may give an incentive for the content viewed by the user to the related content supplier with reference to the user information storage means.

Preferably, the incentive means collects a charge from each user who has received the distribution of the content and gives an allocation, calculated from the collected charge at a predetermined rate, as an incentive to the content supplier.

Preferably, the content includes a video content to be screened at a theater and the content supplier includes a theater and/or a video content distributor.

For the theater, it corresponds to a place where a video content is screened and people can view the content. Information of a theater includes identification information to identify the corresponding theater. For example, the ID or name of a theater can be used.

According to another aspect of the present invention, a content information processing system, including a distribution apparatus for distributing a content to a terminal of a user via a network and a server for processing information related to each content distributed by the distribution apparatus, is characterized in that the server includes: viewing information processing means for specifying information of a content distributed from the distribution apparatus to the terminal of the user; first storage means for storing information of each content to be provided to a user at a real place and information of each content supplier, who provides the content, such that the information is associated with the other information; viewing history storage means for storing viewing historical information including at least the specified information of the content distributed to the user; and incentive means for extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

According to another aspect of the present invention, a content information processing method, which is executed by a computer, is characterized in that the computer performs the steps of: storing information of each content to be provided to a user at a real place and information of each content supplier, who provides the content, such that the information is associated with the other information; specifying information of a content distributed to a terminal of the user via a network; storing viewing historical information including at least the specified information of the content distributed to the user; and extracting the information of the content viewed by the user from the viewing historical information, specifying the content supplier associated with the extracted content with reference to the first storage means; and giving a predetermined incentive to the specified content supplier in accordance with the description of the content distributed to the user and the number of contents.

The present invention provides a computer program allowing a computer to perform the steps of: storing information of each content to be provided to a user at a real place and information of each content supplier, who provides the content, such that the information is associated with the other information; specifying information of a content distributed to a terminal of the user via a network; storing viewing historical information including at least the specified information of the content distributed to the user; and extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents. The computer program may be recorded in a computer-readable recording medium.

### BRIEF DESCRIPTION OF THE DRAWINGS

FIG. 1 is a schematic diagram showing a mode of the whole structure of a system, to which a content information processing apparatus and a computer program according to the present invention are applied.

FIG. 2 is a diagram showing an example of data stored in a member database according to the present mode.

FIG. 3 is a diagram showing an example of data stored in a theater database according to the present mode.

FIG. 4 is a diagram showing an example of data stored in a distributor database according to the present mode.

FIG. 5 is a diagram showing an example of data stored in a content management database according to the present mode.

FIG. 6 is a diagram showing an example of data stored in a viewing history database according to the present mode.

FIG. 7 is a diagram showing an example of data stored in a payment management database according to the present mode.

FIG. 8 is a diagram showing an example of data stored in a charge table according to the present mode.

FIG. 9 is a flowchart of a process based on a content distribution method according to a first embodiment of the present invention.

FIG. 10 is a flowchart of the process based on the content distribution method according to the first embodiment, FIG. 10 following FIG. 9.

FIG. 11 is a diagram showing an example of a membership registration screen according to the present embodiment.

FIG. 12 is a diagram showing an example of a content selection screen according to the first embodiment.

FIG. 13 is a flowchart of a process based on a content distribution method according to a second embodiment of the present invention.

FIG. 14 is a flowchart of the process based on the content distribution method according to the first embodiment, FIG. 14 following FIG. 13.

FIG. 15 is a diagram showing an example of a content selection screen according to the second embodiment.

FIG. 16 is a flowchart of a process based on a content distribution method according to a third embodiment of the present invention.

FIG. 17 is a flowchart of the process based on the content distribution method according to the first embodiment, FIG. 17 following FIG. 14.

FIG. 18 is a diagram showing an example of a membership registration screen according to the third embodiment.

### BEST MODE FOR CARRYING OUT THE INVENTION

A mode according to the present invention will now be described below with reference to the drawings.

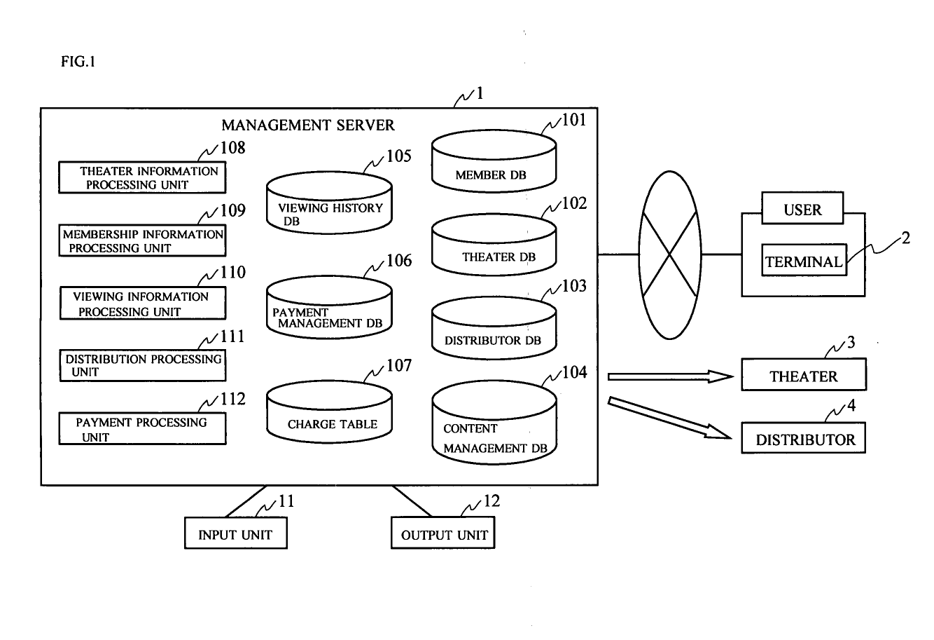

FIG. 1 shows a mode in which a content information processing apparatus and a computer program according to the present invention are utilized.

Referring to FIG. 1, a system includes a management server 1 and a plurality of terminals 2 which are connectable to the management server 1 via the Internet.

In this mode, a theater 3 to screen a movie and a distributor 4 for providing video contents such as movies to the theater and the management server 1 exist. An Internet-connectable terminal can be arranged in each of the theater 3 and the distributor 4 so that information is transmitted or received to/from the management server 1 using a Web page or an electronic mail.

Each terminal 2 is a computer used by a member serving as a user and a viewer. The terminal 2 is connectable to the Internet by a predetermined browser. The terminal 2 holds a viewer program to play a predetermined video file, so that the terminal 2 can receive a video content transmitted from the management server 1 and play the video content. Any existing viewer program can be used.

The terminal 2 can include, for example, a so-called personal computer, a mobile phone unit, or a PDA (Personal Digital Assistance). In addition, the terminal 2 can be a fixed type terminal which is disposed and used at a predetermined place or a removable or hand-held type terminal which the viewer can carry.

The management server 1 functions as a content information processing apparatus according to the present invention.

The management server 1 includes a computer having a CPU (Central Processing Unit), a computer program executed by the CPU, internal memories such as a RAM and a ROM which can store the computer program and other data, and an external storage device such as a hard disk drive to realize functional blocks shown in FIG. 1.

The functional blocks shown in FIG. 1 include a member database 101, a theater database 102, a distributor database 103, a content management database 104, a viewing history database 105, a payment management database 106, a charge table 107, a theater information processing unit 108, a membership information processing unit 109, a viewing information processing unit 110, a distribution processing unit 111, and a payment processing unit 112.

An input unit 11 such as a mouse or a keyboard and an output unit 12 such as a display or a printer are connected to the management server 1 so that information can be input and output.

The member database 101 stores information related to the viewers serving as members.

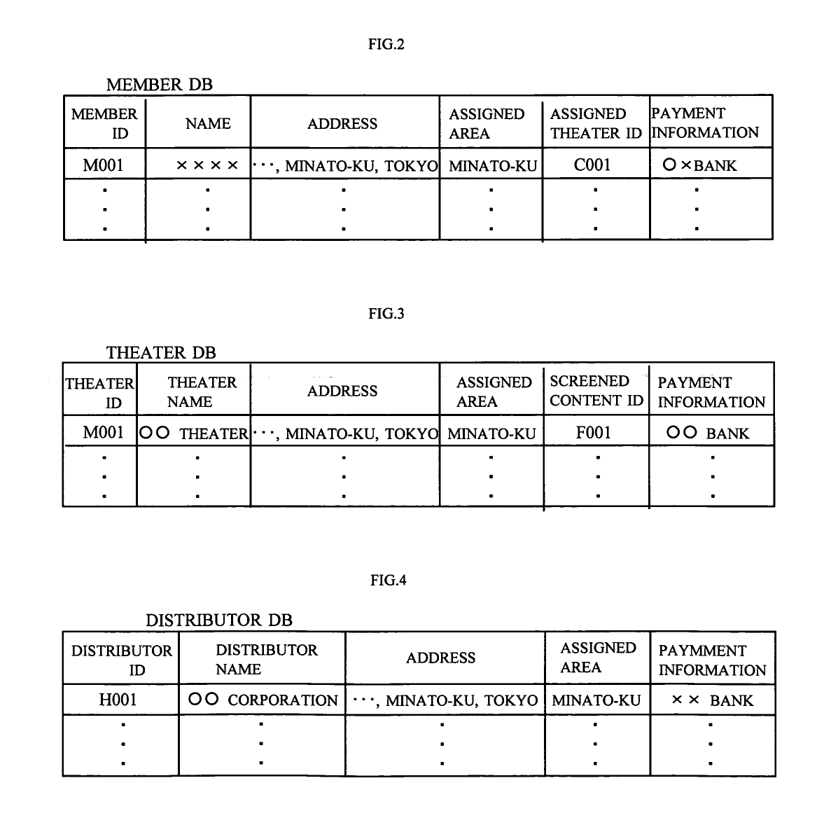

In the member database 101, for example, as shown in FIG. 2, a member ID and a name as identification information of each member, and the address of each member, a assigned area to which the member belongs, the ID of an assigned theater, and payment information can be stored.

For the assigned area, the address or a living place of the member exists in the area. Alternatively, the member selects an area. The area may be on, e.g., a prefecture basis or a predetermined administrative section basis such as a municipality basis. A manager of the management server 1 can arbitrarily set division areas.

The assigned theater ID is identification information to specify the theater 3 associated with the member.

The assigned theater ID is identification information assigned in order to identify the corresponding theater 3. Instead of the assigned theater ID, information such as a theater name to identify the corresponding theater 3 may be stored.

The payment information is used to pay a charge for a content viewed by the member and includes, e.g., bank account information and a credit card number.

If the assigned area and the assigned theater ID are not needed, it is unnecessary to store those information items.

In addition, the e-mail address of the member and information related to the type or genre of the member's favorite movie can also be stored.

The theater database 102 stores information related to theaters 3 for screening movies.

In the theater database 102, for example, as shown in FIG. 3, a theater ID and a name to identify the corresponding theater 3, the address of the theater, a target area, the content ID of a content which is screened at the theater 3, and payment information can be stored.

Target area information indicates an area to which the theater 3 belongs. Each target area corresponds to an assigned area to which a member belongs to. The target area may be on, e.g., a prefecture basis or a predetermined administrative section basis such as a municipality basis. The manager can arbitrarily set division areas as target areas.

Payment information is used to receive the allocation of a charge paid for a content viewed by a member and includes, e.g., bank account information of the corresponding theater 3.

The distributor database 103 stores information related to distributors 4 for distributing movie contents.

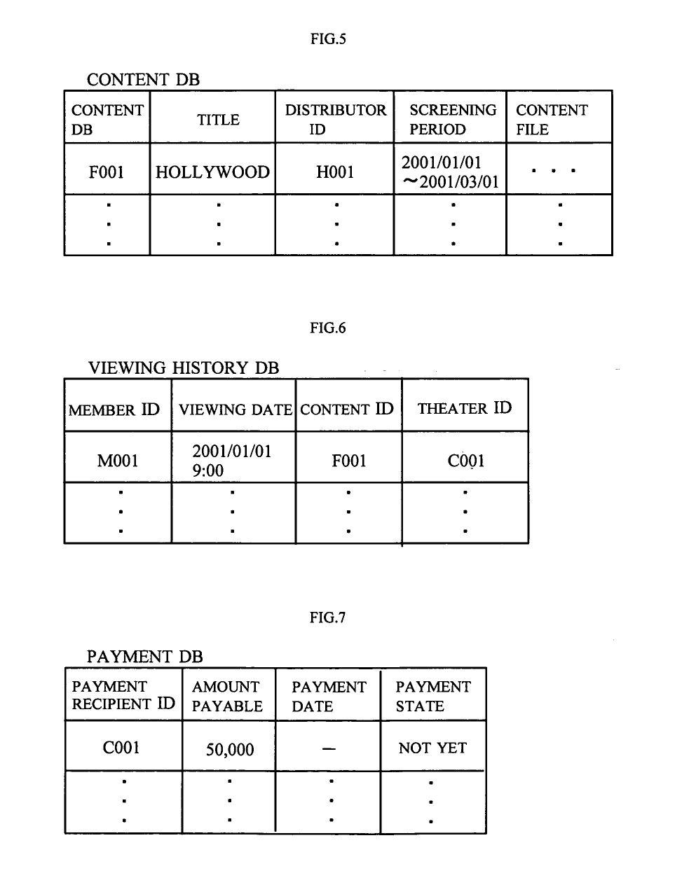

As shown in FIG. 4, in the distributor database 103, a distributor ID and a distributor's name to identify the corresponding distributor 4, the address of the distributor 4, a target area, and payment information such as bank account information used to receive the allocation of a charge can be stored.

The content management database 104 stores movie contents.

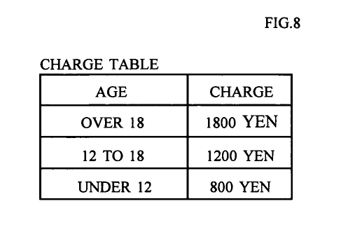

In the content management database 104, for example, as shown in FIG. 5, a content ID and a title to identify the corresponding content, the distributor ID of the distributor 4 which distributes the content, a screening period, and a content file serving as video data can be stored.

The screening period indicates a period during which the corresponding content can be distributed to the members via the Internet. The distributor 4 or the manager of the management server 1 can determine the period. The period can be arbitrarily determined. The screening period may be linked with the screening periods of the content at actual theaters 3. Alternatively, it is unnecessary to link the screening period with those at the theaters 3.

The viewing history database 105 stores information related to the viewing history of each member.

In the viewing history database 105, for example, as shown in FIG. 6, a member ID to specify the corresponding member who viewed a content, viewing data to specify a viewing date, a content ID indicating the viewed content, and a theater ID to specify a theater 3 which receives the allocation of a charge for the viewing can be stored as historical information.

The payment management database 106 is a database to manage the amounts of money to be paid to the theaters 3 and the distributors 4.

In the payment management database 106, as shown in FIG. 7, a theater ID or a distributor ID as a payment recipient ID, an amount payable, a payment date, a payment state indicating whether payment is completed or not can be stored.

The charge table 107 stores a charge made to each member for viewing a content. In the charge table 107, for example, as shown in FIG. 8, charges per viewing by generation can be stored.

The charge table 107 may be common to all of the contents and the theaters 3. Alternatively, the charge table 107 can be provided every content or theater 3. The charge table 107 can be arbitrarily set. Regarding setting charges, for example, a charge for a new movie content can be set high and that for an old movie content can be set low. Alternatively, a charge for a movie content whereby the theaters 3 have a large attendance can be set high and that whereby the theaters 3 have a small attendance can be set low. In addition, a charge can be varied depending on the age or sex of a member. For example, a charge for children of elementary age or younger can be set to 800 yen, that for junior and senior high school students can be set to 1200 yen, and that for adults can be set to 1800 yen.

The theater information processing unit 108 performs a process of registering identification information of the theater 3 or the distributor 4 and a movie content, which is screened at the theater 3 or is distributed by the distributor 4, or the content ID of the movie content such that the identification information is associated with the content or the content ID.

The registration process can be performed on the Web page of the Internet by the theater 3 or the distributor 4 using their terminal 2. Alternatively, information written in a predetermined sheet can be input by the input unit 11 of the management server. The registration process can arbitrarily be performed.

The membership information processing unit 109 registers membership information such as assigned area information of each member.

For example, the membership information processing unit .109 receives information entered on a predetermined Web page for membership registration, so that membership information can be registered.

The membership information processing unit 109 can also generate a member ID to a new member and authenticate a member.

The viewing information processing unit 110 performs a process of accepting a content data distribution request from a member. For example, the viewing information processing unit 110 accepts predetermined information such as the content ID or title of a content, which a member desires to receive the distribution, on a Web page for the content data distribution request, so that the distribution request can be accepted.

The viewing information processing unit 110 also specifies the theater 3 to which the allocation of a charge as an incentive is given.

The distribution processing unit 111 functions as distribution means for distributing a content, of which the distribution is requested by a member, to the member terminal 2 via the Internet.

Each content can be distributed in an arbitrary manner. For example, a content can be distributed by streaming. Alternatively, in response to a download request from a member, the content video file can be transmitted to the member terminal 2.

The payment processing unit 112 calculates the allocation of a charge as an incentive to be given to the theater 3 or the distributor 4 for the video content distributed to the member.

On the basis of a result of the calculation, the payment processing unit 112 can collect a charge from the member based on payment information of the member or the theater 3 and then pays the allocation of the collected charge to the theater 3 or the distributor 4. Regarding the charge collection and the payment, for example, a payment request can be performed to a payment system of a predetermined bank or a credit card company (not shown).

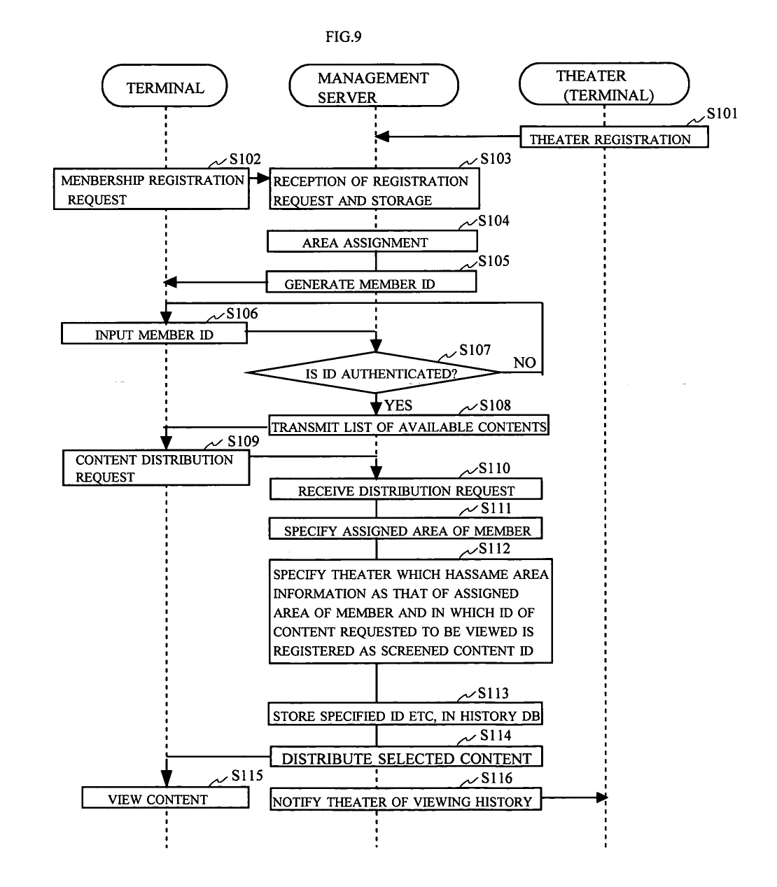

A content distribution method according to a first embodiment of the present invention will now be described with reference to FIG. 9.

Referring to FIG. 9, first, each theater 3 registers theater information using a predetermined terminal and each distributor 4 registers distributor information using a predetermined terminal (S101). The theater information processing unit 108 enters the registered information of the theater 3 in the theater database 102. When a video content is registered by the theater 3 or the distributor 4, the theater information processing unit 108 stores the video content in the content management database 104.

Regarding a target area, the theater information processing unit 108 can assign a target area to the theater 3 or the distributor 4 on the basis of address information of the theater 3 or the distributor 4. Alternatively, each of the theater 3 and the distributor 4 can select a target area.

A person who desires to become a member accesses a Web page for membership registration using the terminal 2 and then inputs predetermined membership information to generate a membership registration request to the management server 1 (S102). The membership information processing unit 109 accepts the input membership information and stores the information in the member database 101 (S103).

As shown in FIG. 11, for example, the Web page for membership registration can include fields 1001 where a person, who registers membership, inputs their name, address, e-mail address, and payment information, and fields 1002 where the person inputs their favorite type of movie such as a Japanese movie or a foreign movie and their favorite genre of movie such as a sci-fi movie or a cartoon movie. The person, who generates a registration request, inputs data of the above items on the input screen using the terminal 2. The person can generate the registration request by clicking a register button 1003 on the Web page.

After the registration request is generated, the membership information processing unit 109 assigns an area to the member on the basis of the input address and stores the assigned area in the member database 101 (S104).

Regarding the area assignment, for example, the membership information processing unit 109 can extract a prefecture name or a municipality name from the input address and register the name as area information. When the member is permitted to select an area, the selected area is assigned to the member.

The member is permitted to previously select an assigned area. In this case, the membership information processing unit 109 stores the selected area as an assigned area in the member database 101.

After membership information is registered, the membership information processing unit 109 generates a member ID to the member to notify the member of the member ID, and stores the member ID in the member database 101 (S105).

For the generation of member IDs, the membership information processing unit 109 can number members under predetermined rules, i.e., in the order in which the members are accepted and in ascending order. The member ID is generated, thus completing the membership registration.

To obtain a desired content from the management server 1 in order to view the content, each member accesses a Web page for content distribution request reception using the terminal 2 and inputs the assigned member ID on a Web page for authentication to generate a login request (S106). The membership information processing unit 109 refers to the member database 101 to determine whether the input member ID is authenticated (S107).

As a result of the determination, if the member ID is not authenticated, the membership information processing unit 109 notifies the member terminal 2 that the input member ID is not authenticated. The process is returned to the login step in S106.

If the member ID is authenticated, the viewing information processing unit 110 refers to the content management database 104 with respect to a screening period, extracts contents to be screened at present, and transmits information as a list of the contents to the member terminal 2 (S108).

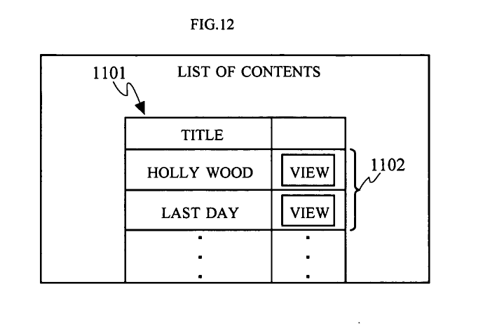

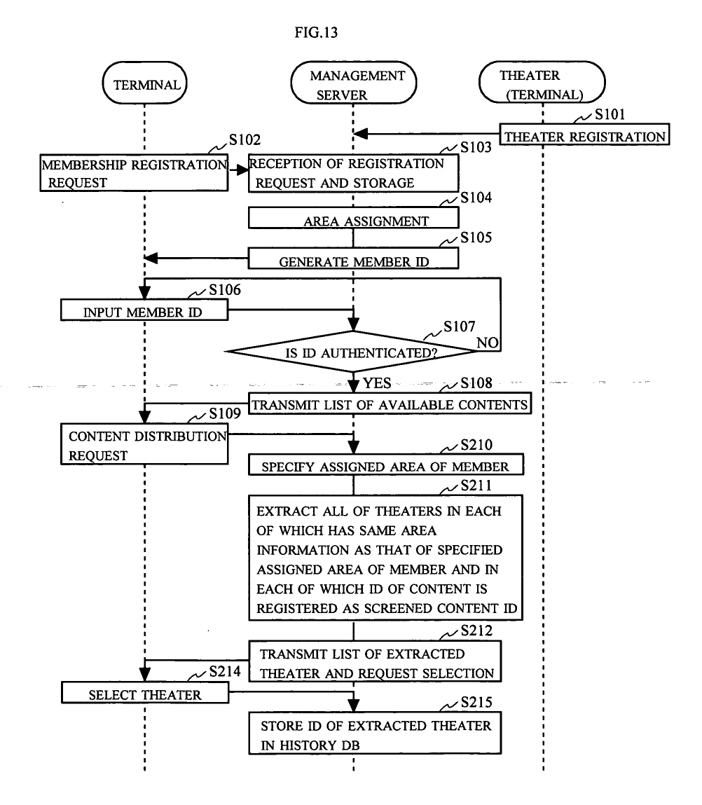

As an example, referring to FIG. 12, the viewing information processing unit 110 displays a content title 1101 and select buttons 1102 to select the corresponding content on a Web page regarding the extracted current available contents so that the member can select a desired content.

The member clicks the select button for the desired content in the content list through the terminal 2 to select the content, thus transmitting a distribution request (S109). The viewing information processing unit 110 accepts the content distribution request (S110).

The viewing information processing unit 110 refers to the member database 101 to specify the assigned area of the member (S111).

The viewing information processing unit 110 refers to the theater database 102 to specify the theater 3, which has the same area information as that of the specified assigned area of the member and in which the ID of the content requested by the member to be viewed is registered as the ID of a content to be screened (S112).

The viewing information processing unit 110 stores the ID of the specified theater, the member ID of the member who requests to view the content, viewing date, and the ID of the content requested to be viewed in the viewing history database 105 (S113).

The distribution processing unit 111 refers to the content management database 104 and distributes the content, requested by the user to be distributed, to the member terminal 2 over the Internet (S114).

Thus, the viewer can watch the content through the terminal 2 (S115). The distribution can be performed to the member terminal 2 by steaming through the distribution processing unit 111. Alternatively, the content can also be distributed as a file in response to a download request from the member. The content can be distributed in an arbitrary manner.

The viewing information processing unit 110 notifies the theater 3 and the distributor 4 of viewing historical information of the member (S116). The content distribution process is completed. The viewing historical information can be transmitted through a predetermined Web page or an e-mail to a computer managed by the theater 3. Alternatively, the information can also be sent by mail every predetermined period, e.g., monthly.

Information to be transmitted can include the content ID of the content viewed by the member, the title thereof, and viewing date.

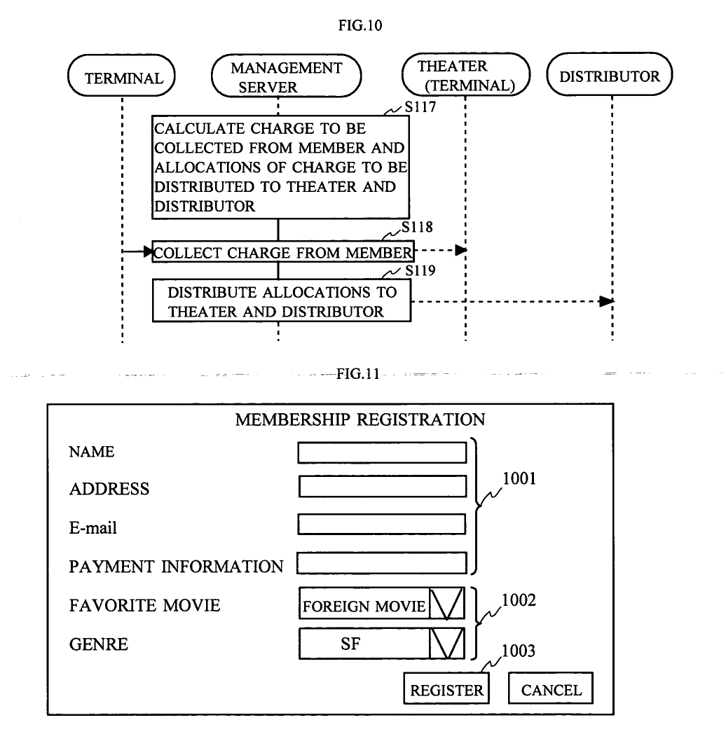

Referring to FIG. 10, after the content distribution is completed, the payment processing unit 112 refers to the viewing history database 105 at predetermined timing, calculates a charge to be collected from the member and the allocations of the charge to the theater 3 and the distributor 4, and stores the calculated data in the payment management database 106 (S117). For the calculation of a charge to be collected from each viewer, for instance, the payment processing unit 112 can calculate the amount of charge in accordance with the number of content viewing times with reference to the charge table 107.

On the basis of payment information of the member database 101, the payment processing unit 112 collects the charge from the member through the system of the credit card company (S118).

On the basis of payment information pieces of the theater 3 and the distributor 4, the payment processing unit 112 gives the allocations of the charge to the theater 3 and the distributor 4 (S119). The process then terminates.

Regarding the allocations to the theater 3 and the distributor 4, the ratio of allocation of the theater 3 and that of the distributor 4 is predetermined and the charge can be distributed between the theater 3 and the distributor 4 at the predetermined ratio. If there are a plurality of theaters 3, the allocation can be evenly distributed among the theaters 3. Alternatively, the allocation can be distributed among the theaters in a predetermined ratio depending on various conditions such as attendance, the number of screening days, whether the screening period is early or late.

According to the above-mentioned first embodiment, information related to each theater 3 which actually screens a content and information related to the content screened at the theater 3 are registered. When the content is distributed via the Internet, the viewing information processing unit 110 specifies the theater 3 in which the ID of the content requested by the member to be viewed is registered as the screened content ID. The payment processing unit 112 gives the allocation of a charge as an incentive to the specified theater 3. If the content which is actually screened at the theater 3 is distributed via the Internet or the like, therefore, a profit corresponding to the distribution is allocated to the theater 3 which actually screens the movie. Thus, the theater 3 can earn a profit in the same way as a case that the member watches a movie at the theater 3. Advantageously, the theater 3 loses no profits.

According to the above first embodiment, area information as information related to each theater 3 and an assigned area as information related to each viewer are registered. When a content is distributed to the viewer over the Internet, the viewing information processing unit 110 specifies the theater 3 which has area information matching the assigned area of the user. The payment processing unit 112 gives the allocation of a charge as an incentive to the specific theater 3. Consequently, even when the content is distributed to the user who lives in or often goes to the area of the theater 3 and can be expected as a customer of the theater 3, the allocation of a charge corresponding to the distribution is given to the theater 3. Therefore, the theater 3 can earn a profit in the same way as the case that the member watches a movie at the theater 3. Advantageously, the theater 3 loses no profits.

In addition, the viewing information processing unit 110 notifies the specific theater 3 of historical information such as identification information of each content viewed by each viewer. Thus, the theater 3 can have an opportunity to independently provide services (e.g., a coupon of the theater 3 or a point service) to the members.

Not only contents which are being screened currently but also movie contents which will be screened or have been screened can be associated with each theater 3. Consequently, even when the theater 3 does not currently screen a content, the theater 3 can receive an incentive for the content. Thus, an equitable distribution of incentives can be realized among the theaters 3 having different screening periods.

A second embodiment of the present invention will now be described. The same components and the same processing steps as those of the above-mentioned first embodiment are designated by the same reference numerals and the description thereof is omitted.

The second embodiment relates to a case where each member selects a content and also selects a theater 3.

Referring to FIG. 13, the processing steps up to S109 are performed in a manner similar to the above first embodiment. When a member selects a viewing content from the content list, the viewing information processing unit 110 specifies the assigned area of the member with reference to the member database 101 (S210).

After specifying the assigned area of the member, the viewing information processing unit 110 refers to the theater database 102 to extract information pieces of all of theaters, each of which has the same area information as that of the assigned area of the specified member and in each of which the ID of the content requested by the member to be viewed is registered as the screened content ID (S211).

The viewing information processing unit 110 displays a list of the extracted theater information pieces on a Web page to request the user to select a theater (S212).

When requesting the selection, as shown in FIG. 15, the viewing information processing unit 110 may display theater names 2002, areas 2003, select buttons 2004, and advertising information pieces 2005 previously registered by the respective theaters 3 as a list 2001 of the theaters 3. Each theater 3 can arbitrarily determine advertising information such as the URL of the Web site of the theater 3. Regarding the contents of advertisement, for example, each theater 3 can give a point to each member who selects the theater 3 depending on the number of viewing times or the amount of charge. Alternatively, a reserved seat coupon or a coupon for the theater 3 can be distributed.

The ID of the theater selected by the member is stored in the viewing history database 105 (S215).

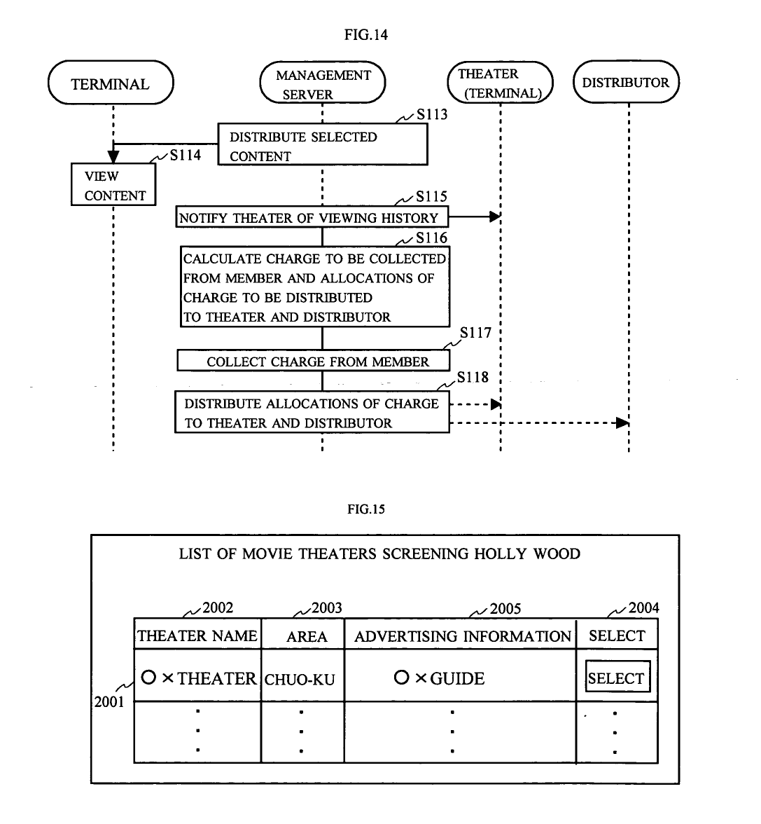

Referring to FIG. 14, the same processing steps as those from S113 mentioned above are performed for content distribution, charge calculation, and payment processing. The process then terminates.

As mentioned above, according to the second embodiment, information pieces of the theaters 3 are provided to the member every content, each theater screening a movie corresponding to the content. The allocation of a charge is given to the theater 3 selected by the member. Accordingly, the member can select their favorite theater 3. Thus, the member can have an opportunity to select a theater 3 which the member wants to support or their favorite theater 3 with high priority.

When the member selects among the theater 3, advertising information pieces of the respective theaters 3 are provided to the member. Therefore, the member can receive a service from each theater 3. In addition, since advertising information pieces of the theaters 3 are distributed to each customer who receives a content, there is a high possibility that the customer will actually go to a movie. Thus, an increase in box-office profit of each theater 3 can be expected. Therefore, the theaters 3 compete against one another, so that the theaters 3 provide better services to the members.

In the above description, the above-mentioned embodiments relate to the case where the viewing information processing unit 110 specifies the theater 3, in which the ID of the content requested by the member to be viewed is registered as the screened content ID and which has area information matching the assigned area of the member. An incentive can be given to each theater 3 which satisfies any of the above conditions. In other words, the viewing information processing unit 110 specifies the theaters 3 in each of which the ID of the content requested by the member to be viewed is registered as the screened content ID. An allocation can be distributed among the specified theaters 3. Alternatively, the viewing information processing unit 110 specifies the theaters 3 each having area information matching the assigned area of the member. An allocation can be distributed among the specified theaters 3.

The process of specifying the theaters 3, each having the screened content ID matching the ID of the content requested by the member to be viewed, through the viewing information processing unit 110 can be performed in distributing the content to the member as mentioned in the embodiments. Alternatively, the process can also be performed in calculating the allocation of a charge. The process can be performed at arbitrary time. Similarly, the process of specifying the theaters 3, each having area information matching the assigned area of the member, through the viewing information processing unit 110 can be performed in distributing the content to the member in the same way as the above embodiments. Alternatively, the process can also be performed in calculating the allocation of a charge. The process can be performed at arbitrary time.

When the process is performed in calculating the allocation of a charge, the viewing information processing unit 110 may perform the process with reference to the viewing history database 105.

A third embodiment of the present invention will now be described.

The third embodiment relates to a case where each member registers a theater 3, which the member belongs to, upon membership registration and the allocation of a charge is given to the registered theater 3 each time the member views a content. The same components as those of the above-mentioned embodiments are designated by the same reference numerals and the description thereof is omitted.

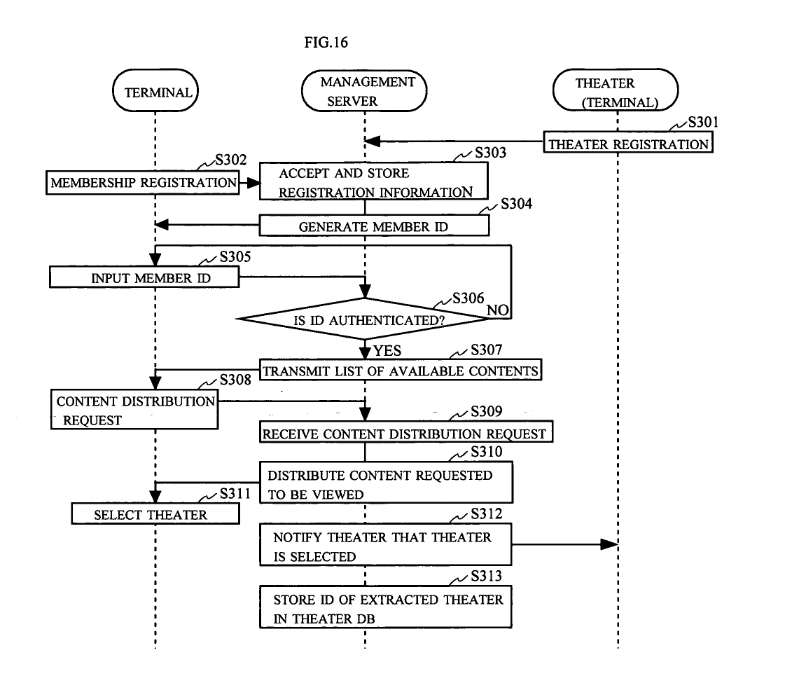

Referring to FIG. 16, first, each theater 3 registers theater information using a predetermined terminal or the like and each distributor 4 registers distributor information through a predetermined terminal (S301). At that time, the theater information processing unit 108 can assign a target area to each of the theater 3 and the distributor 4 based on address information of each of the registered theater 3 and the registered distributor 4. Each of the theater 3 and the distributor 4 can select a target area.

A person who wants to become a member accesses the Web page for membership registration and inputs predetermined registration information using the terminal 2 to generate a membership registration request to the management server 1 (S302). The membership information processing unit 109 accepts the input registration information and stores the information in the member database 101 (S303).

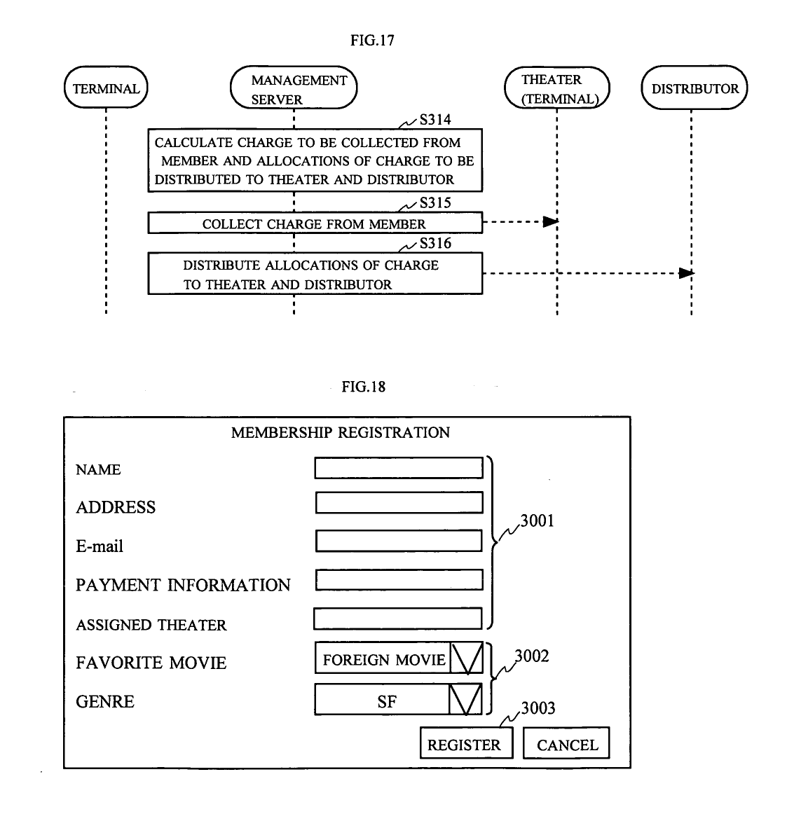

As shown in FIG. 18, for example, the Web page for membership registration can include fields 3001 where each viewer inputs their name, address, e-mail address, and payment information, and a theater 3 to which the viewer belongs and fields 3002 where the viewer inputs their favorite type of movie such as a Japanese movie or a foreign movie and their favorite genre of movie such as a sci-fi movie or a cartoon movie. The viewer inputs the above data through the terminal 2. The viewer can generate the registration request by clicking a register button 3003 on the page.

One or a plurality of theaters 3 to which the viewer belongs can be registered.

When the member selects among the theaters 3, a list of the theaters 3 and advertising information related to services of the respective theaters 3 for the member are provided. The member can select at least one desired theater 3 from the list of theaters 3.

After membership information is registered, the membership information processing unit 109 generates a member ID to the viewer and stores the member ID in the member database 101 (S304). For the generation of member IDs, the membership information processing unit 109 can number members under predetermined rules, e.g., in the order in which the members are accepted and in ascending order.

To receive the distribution of a content, the member accesses the Web page for content distribution request reception using the member terminal 2 and inputs the assigned member ID on the Web page for authentication to generate a login request (S305). The membership information processing unit 109 refers to the member database 101 to determine whether the input member ID is registered (S306).

As a result of the determination, if the member ID is not authenticated, the membership information processing unit 109 notifies the member terminal 2 that the input member ID is not authenticated. The process is returned to the foregoing step in S305.

As the determination result, if the member ID is authenticated, the viewing information processing unit 110 refers to the content management database 104, extracts content data which is available at present, and transmits the data to display a list of contents on the Web page as shown in, e.g., FIG. 12 so that the member can select a desired content (S307).

The member clicks the select button for the desired content in the content list on the Web page through the member terminal 2 to transmit a content distribution request (S308). The viewing information processing unit 110 receives the content distribution request (S309).

When a viewing request is generated, the distribution processing unit 111 refers to the content management database 104 and distributes the content requested to be distributed to the member terminal 2 via the Internet (S310). Thus, the viewer can view the content using the terminal 2 (S311).

The viewing information processing unit 110 specifies the theater 3 which the member belongs to with reference to the member database 101 and notifies the theater 3 that the member views the content (S312).

The viewing information processing unit 110 stores the theater ID of the assigned theater 3 of the member, the member ID of the member who has generated the viewing request, viewing time, and the ID of the content requested to be viewed in the viewing history database 105 (S313).

After the viewing is finished, the payment processing unit 112 refers to the viewing history database 105 at predetermined timing, calculates a charge to be collected from the member and allocations of the charge given to the theater 3 and the distributor 4 based on the charge table 107, and stores the calculated data in the payment management database 106 (S314).

On the basis of payment information of the member database 101, the payment processing unit 112 collects the charge from the member through the system of the credit card company (S315).

The payment processing unit 112 gives allocations of the collected charge to the theater 3 and the distributor 4 at a predetermined ratio (S316). The process then terminates.

According to the above-mentioned third embodiment, the payment processing unit 112 gives the allocation of a charge to the theater 3, associated to the distributed content, for the content viewed by the member. Even if the content to be screened at the theater 3 is distributed via the Internet, a profit corresponding to the viewing by the member is allocated to the theater 3 which screens the content as a movie. Therefore, the theater 3 can earn profits in the same way as a case where the member watches the movie at the theater 3. Advantageously, the theater 3 loses no profits.

At least one assigned theater is determined every member. The allocation of a charge is stably given to the theater 3 each time the member views a content over the Internet. Even if content distribution leads to a reduction in attendance, the reduction can be compensated.

In addition, the theater 3 can give an incentive to the member depending on the number of viewing times or the amount of charge. The given incentive can encourage the member who has viewed the content to actually visit the theater 3.

According to the above-mentioned embodiments, the case where the allocation of a charge is given as an incentive to the theater 3 has been described. The incentive is not limited to this example. For example, a predetermined point and a valuable merit can also be used.

In each of the above embodiments, the case where the viewer is a member has been described. The present invention is not limited to the case. The present invention can also be intended for general viewers who do not belong to a membership system. In this case, each general viewer may initially input information similar to that for the foregoing membership registration before viewing.

In the above embodiments, the case where a movie content is distributed has been described. The present invention is not limited to the case. Contents can include a video content such as a rental video, a digitized newspaper, a digitized book, a music piece, a map, and a game.

For example, the content supplier may be a rental video shop or a video sales shop. In this case, in the same way as the foregoing embodiments, the description of each content such as a movie distributed from the management server 1 and the number of contents are managed. A predetermined rental video shop or sales shop can receive an incentive according to the contents of their management.

In this case, information related to the address of the rental video shop and the number of video tapes bought by the rental video shop are stored in the management server 1. In distributing incentives, the payment processing unit 112 can calculate each incentive so that the amount of money as an incentive varies depending on the number of video tapes of the same movie bought by the corresponding rental video shop. For example, the amount of money as an incentive for a rental video shop which bought five tapes can be 1.5 times and that for another rental video shop which bought ten tapes can be two times.

An incentive can also be given to a user. For instance, after a content such as a movie is distributed to a user from the management server 1 via a network, the management server 1 stores information related to the user who has watched the movie in the member database 101 within a predetermined period (e.g., one week). When the movie is videoized and is then sold or rented, the payment processing unit 112 refers to the member database 101 to extract the user who has viewed the movie within the predetermined period. A large allocation can be given to the user (e.g., a double incentive is given to a user who has received the distribution of a movie within one week after the movie was released on the Web). Consequently, an incentive can be given to a user. This leads the user to early watch a movie.

For the sake of investing, a user can previously buy a content such as a movie, which will be distributed over the Internet and which the user expects a big seller, so as to obtain the right to obtain an allocation. A viewer on the Internet can recommend a movie which the viewer has watched to their friend via e-mail. If the friend watches the movie, a predetermined incentive can be given to the recommender.

In the above-mentioned embodiments, the case where the process is performed via the Internet has been explained. The present invention is not limited to the case. A telephone network, a LAN, or a broadcasting network, or the combination of those networks can realize the system. Any of cable communication and radio communication can be used.

In the above embodiments, RIP in every place can be distributed among a plurality of computers to be processed by the computers. Alternatively, computers respectively having the databases can be distributed and they can cooperate with each other to realize the system. The system can have an arbitrary structure. For example, in the above embodiments, the case where the management server 1 distributes a content to a user has been explained. The present invention is not limited to the case. A content distribution apparatus can be arranged separately from the management server 1. In this case, the management server 1 can obtain viewing information related to a user via a network from the content distribution apparatus and then allocate an incentive to the user based on the viewing information.

A computer program for the management server 1 according to the embodiments can be stored into a computer-readable medium (e.g., an FD, a CD-ROM, or the like) and then be distributed.

The computer program for the management server 1 can be superimposed on carrier waves and then be distributed via a communication network. For example, the program is provided on a bulletin board system (BBS) of a communication network. The program can be distributed via the network.

When the above-mentioned functions are supported by an OS (Operating System) or the functions are realized by the OS and an application program in collaboration with each other, components other than the OS correspond to a computer program. The computer program can be stored in a computer-readable medium.

### INDUSTRIAL APPLICABILITY

According to the present invention, a mechanism whereby a user can obtain a desired content via a communication network and a content distributor loses no profits can be provided.

1. A content information processing apparatus characterized by comprising:
first storage means for storing information of each content to be provided to a user at a real place and information of each content supplier, who provides the content, such that the information is associated with the other information;
viewing information processing means for specifying information of a content distributed to a terminal of the user via a network;
viewing history storage means for storing viewing historical information including at least the specified information of the content distributed to the user; and
incentive means for extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

2. The content information processing apparatus according to claim 1, further comprising distribution means for distributing a content to the terminal of each user.

3. The content information processing apparatus according to claim 1, wherein the apparatus is connectable via a communication network to a content distribution terminal for distributing a content to each user over a network, and the viewing information processing means obtains viewing historical information of a content distributed from the terminal of the content distributor to the user.

4. The content information processing apparatus according to claim 1, further comprising:
second storage means for storing at least identification information of each user and assigned-area information indicating an area which the user belongs to, wherein
the first storage means further stores assigned-area information indicating an area which each content supplier belongs to, and
the incentive means specifies area information of a user, to which the content is distributed, with reference to the second storage means, specifies the content supplier belonging to the specified area with reference to the first storage means, and gives an incentive to the specified content supplier for the content distributed to the user.

5. The content information processing apparatus according to claim 4, further comprising:
registration means for accepting registration of assigned-area information indicating an area, to which a viewer belongs, to store the information in the second storage means.

6. The content information processing apparatus according to claim 1, wherein the viewing information processing means provides viewing historical information to each content supplier.

7. The content information processing apparatus according to claim 1, wherein
with reference to the first storage means, the viewing information processing means provides each user with the information pieces of the content suppliers registered in association with the content viewed by the user and accepts the information of a desired content supplier selected from among the content suppliers by the user, and
the incentive means gives an incentive to the content supplier accepted from the user.

8. The content information processing apparatus according to claim 7, wherein
the first storage means further stores advertising information of each content supplier, and
when providing each user with the information pieces of the content suppliers, the viewing information processing means provides the user with the advertising information pieces of the content suppliers stored in the first storage means.

9. The content information processing apparatus according to claim 1, further comprising:
user information storage means for relating each user to a content supplier to store the relationship therebetween, wherein
the incentive means gives an incentive for the content viewed by the user to the related content supplier with reference to the user information storage means.

10. The content information processing apparatus according to claim 1, wherein the incentive means collects a charge from each user who has received the distribution of the content and gives an allocation, calculated from the collected charge at a predetermined rate, as an incentive to the content supplier.

11. The content information processing apparatus according to claim 1, wherein
the content includes a video content to be screened at a theater, and
the content supplier includes a theater and/or a video content distributor.

12. A content information processing system including a distribution apparatus for distributing a content to a terminal of the user via a network and a server for processing information related to each content distributed by the distribution apparatus, characterized in that the server comprises:
viewing information processing means for specifying information of a content distributed from the distribution apparatus to the terminal of the user;
first storage means for storing information of each content to be provided to a user at a real place and information of each content supplier, who provides the content, such that the information is associated with the other information;
viewing history storage means for storing viewing historical information including at least the specified information of the content distributed to the user; and
incentive means for extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

13. A content information processing method executed by a computer, characterized in that
the computer performs the steps of:
storing information of each content to be provided to a user at a real place and information of each content supplier, who provides the content, such that the information is associated with the other information;
specifying information of a content distributed to a terminal of the user via a network;
storing viewing historical information including at least the specified information of the content distributed to the user; and
extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

14. A computer program allowing a computer to perform the steps of:
storing information of each content to be provided to a user at a real place and information of each content supplier, who provides the content, such that the information is associated with the other information;
specifying information of a content distributed to a terminal of the user via a network;
storing viewing historical information including at least the specified information of the content distributed to the user; and
extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.

15. A computer-readable recording medium storing a computer program which allows a computer to perform the steps of:
storing information of each content to be provided to a user at a real place and information of each content supplier, who provides the content, such that the information is associated with the other information;
specifying information of a content distributed to a terminal of the user via a network;
storing viewing historical information including at least the specified information of the content distributed to the user; and
extracting the information of the content viewed by the user from the viewing historical information, specifying the content supplier associated with the extracted content with reference to the first storage means, and giving a predetermined incentive to the specified content supplier in accordance with the description of the content distributed to the user and the number of contents.
